(19) United States
(12) Patent Application Publication
(10) Pub. No.: US 2025/0089099 A1
(43) Pub. Date: Mar. 13, 2025

(54) METHODS AND APPARATUSES FOR RANDOM ACCESS PROCEDURE IN FULL DUPLEX MODE

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Yingying Li, Beijing (CN); Haiming Wang, Beijing (CN)

(73) Assignee: Lenovo (Beijing) Limited, Beijing (CN)

(21) Appl. No.: 18/723,156

(22) PCT Filed: Dec. 24, 2021
(86) PCT No.: PCT/CN2021/141356

§ 371 Date: Jun. 21, 2024

(51) Int. Cl. H04W 74/0833; H04W 74/00

(52) U.S. Cl. CPC H04W 74/0833; H04W 74/002

(57) ABSTRACT

Disclosed are methods and apparatuses for random access (RA) procedure in full duplex mode. An embodiment of the subject application provides a user equipment (UE). The UE includes a processor and a wireless transceiver coupled to the processor. The processor is configured to: receive, with the wireless transceiver, a Bandwidth Part (BWP) configuration for at least a uplink (UL) BWP from a base station (BS), and determine a set of valid Random Access Channel (RACH) Occasions (ROs) within the UL BWP for FD functionality, wherein the BS is able to perform reception in the UL BWP with the UE when the BS performs transmission in a downlink (DL) BWP with another UE.

### TECHNICAL FIELD

The present disclosure generally relates to wireless communication technologies, and especially relates to methods and apparatuses for random access (RA) procedure in full duplex mode.

### BACKGROUND OF THE INVENTION

In wireless communication system, the term “duplex” means bidirectional communication between two devices, where the transmissions over the link in each direction may take place at the same time (i.e., full duplex) or mutual exclusive time (i.e., half duplex).

In legacy transceiver, there may be three duplex modes: time division duplex (TDD), half duplex (HD) frequency division duplex (HD-FDD), and full duplex (FD) FDD (FD-FDD). As shown in FIG. 1, in TDD mode, the same carrier frequency is used for each link direction at different time durations; in HD-FDD mode, different carrier frequencies are used for different link directions, and transmissions in different link directions cannot be performed at the same time; and in FD-FDD mode, different carrier frequencies are used for different link directions, and transmissions in different link directions can be performed at the same time.

### SUMMARY

According to some embodiments of the present disclosure, an exemplary UE is provided. The UE includes: a processor and a wireless transceiver coupled to the processor, wherein the processor is configured to: receive, with the wireless transceiver, a Bandwidth Part (BWP) configuration for at least a uplink (UL) BWP from a base station (BS); and determine a set of valid Random Access Channel (RACH) Occasions (ROs) within the UL BWP for FD functionality, wherein the BS is able to perform reception in the UL BWP with the UE when the BS performs transmission in a downlink (DL) BWP with another UE.

In some embodiments, to determine the set of valid ROs within the UL BWP, the processor is further configured to determine the set of valid ROs within the UL BWP at least based on the BWP configuration.

In some embodiments, the BWP configuration includes a Random Access Channel configuration in the UL BWP for FD functionality, wherein the RACH configuration includes at least one of: a separate PRACH configuration index, or the number of ROs and a start of a first RO within the UL BWP.

In some embodiments, the RACH configuration in the UL BWP for FD functionality is applicable for all slots.

In some embodiments, the RACH configuration in the UL BWP for FD functionality is applicable for a subset of all slots.

In some embodiments, a condition for determining an RO to be within the set of valid ROs includes at least one of: the RO being within a UL symbol configured by a Time Division Duplexing (TDD) UL/DL configuration for FD functionality; or the RO being not before a Synchronization Signal Block (SSB) in a PRACH slot and starting after a last DL symbol indicated by the TDD UL/DL configuration for FD functionality.

In some embodiments, in response to the fact that the RACH configuration is applicable for all slots, the condition for determining the RO to be within the set of valid ROs further includes the RO being within a DL symbol configured by a TDD UL/DL configuration for non-FD functionality.

In some embodiments, in response to the fact that the RACH configuration is applicable for all slots, the condition for determining the RO to be within the set of valid ROs further includes the RO being within a UL symbol configured by a TDD UL/DL configuration for non-FD functionality.

In some embodiments, the processor is further configured to receive, with the wireless transceiver, a first configuration, wherein in response to the fact that the RACH configuration is applicable for all slots and the RO meets the condition, whether the RO is determined to be within the set of valid ROs further depends upon the first configuration.

In some embodiments, in response to the fact that the RACH configuration is applicable for a subset of all slots, the condition for determining the RO to be within the set of valid ROs includes the RO being within a DL symbol configured by a TDD UL/DL configuration for non-FD functionality.

In some embodiments, the set of valid ROs includes at least one of: at least one separate valid RO, or at least one shared valid RO for both FD functionality and non-FD functionality.

In some embodiments, the processor is further configured to receive, with the wireless transceiver, at least one SSB associated with the at least one separate valid RO which is separated from at least one SSB associated with at least one RO for non-FD functionality.

In some embodiments, the processor is further configured to, with the wireless transceiver, receive a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, the processor is further configured to, with the wireless transceiver, receive a third configuration setting a set of preambles in the at least one separate valid RO for a 4-step RA procedure to be available for a 2-step RA procedure.

In some embodiments, the set of preambles are associated with a set of Physical Uplink Shared Channel (PUSCH) Resource Units (PRUs) configured for non-FD functionality.

In some embodiments, the set of preambles are associated with a separate set of PRUs configured for FD functionality different from a set of PRUs configured for non-FD functionality.

According to some embodiments of the present disclosure, an exemplary BS is provided. The BS includes a processor and a wireless transceiver coupled to the processor, wherein the processor is configured to: transmit, with the wireless transceiver, a BWP configuration for at least a UL BWP to a UE, in order to perform reception in the UL BWP with the UE when the BS performs transmission in a DL BWP with another UE; and determine a set of valid ROs within the UL BWP for FD functionality.

In some embodiments, to determine the set of valid ROs within the UL BWP, the processor is further configured to determine the set of valid ROs within the UL BWP at least based on the BWP configuration.

In some embodiments, the BWP configuration includes an RACH configuration in the UL BWP for FD functionality, wherein the RACH configuration includes at least one of: a PRACH configuration index, or the number of ROs and a start of a first RO within the UL BWP.

In some embodiments, the RACH configuration in the UL BWP for FD functionality is applicable for all slots.

In some embodiments, the RACH configuration in the UL BWP for FD functionality is applicable for a subset of all slots.

In some embodiments, a condition for determining an RO to be within the set of valid ROs includes at least one of: the RO being within a UL symbol configured by a TDD UL/DL configuration for FD functionality; or the RO being not before an SSB in a PRACH slot and starting after a last DL symbol indicated by the TDD UL/DL configuration for FD functionality.

In some embodiments, in response to the fact that the RACH configuration is applicable for all slots, the condition for determining the RO to be within the set of valid ROs further includes the RO being not within a UL symbol configured by a TDD UL/DL configuration for non-FD functionality.

In some embodiments, in response to the fact that the RACH configuration is applicable for all slots, the condition for determining the RO to be within the set of valid ROs further includes the RO being within a UL symbol configured by a TDD UL/DL configuration for non-FD functionality.

In some embodiments, the processor is further configured to transmit, with the wireless transceiver, a first configuration, wherein in response to the fact that the RACH configuration is applicable for all slots and the RO is within a UL symbol configured by a TDD UL/DL configuration for non-FD functionality, whether the RO is determined to be within the set of valid ROs further depends upon the first configuration.

In some embodiments, in response to the fact that the RACH configuration is applicable for a subset of all slots, the condition for determining the RO to be within the set of valid ROs includes the RO being within a DL symbol configured by a TDD UL/DL configuration for non-FD functionality.

In some embodiments, the set of valid ROs includes at least one of: at least one separate valid RO, or at least one shared valid RO for both FD functionality and non-FD functionality.

In some embodiments, the processor is further configured to transmit, with the wireless transceiver, at least one SSB associated with the at least one separate valid RO which is separated from at least one SSB associated with at least one RO for non-FD functionality.

In some embodiments, the processor is further configured to transmit, with the wireless transceiver, a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, the processor is further configured to transmit, with the wireless transceiver, a third configuration for setting a set of preambles in the at least one separate valid RO to be available for a 2-step RACH procedure.

In some embodiments, the set of preambles are associated with a set of PRUs configured for non-FD functionality.

In some embodiments, the set of preambles are associated with a separate set of PRUs configured for FD functionality different from a set of PRUs configured for non-FD functionality.

According to some embodiments of the present disclosure, an exemplary method performed by a UE is provided. The method includes: receiving a BWP configuration for at least a UL BWP from a BS; and determining a set of valid ROs within the UL BWP for FD functionality, wherein the BS is able to perform reception in the UL BWP with the UE when the BS performs transmission in a DL BWP with another UE.

In some embodiments, determining the set of valid ROs within the UL BWP includes determining the set of valid ROs within the UL BWP at least based on the BWP configuration.

In some embodiments, the BWP configuration includes an RACH configuration in the UL BWP for FD functionality, wherein the RACH configuration includes at least one of: a separate PRACH configuration index, or the number of ROs and a start of a first RO within the UL BWP.

In some embodiments, the RACH configuration in the UL BWP for FD functionality is applicable for all slots.

In some embodiments, the RACH configuration in the UL BWP for FD functionality is applicable for a subset of all slots.

In some embodiments, a condition for determining an RO to be within the set of valid ROs includes at least one of; the RO being within a UL symbol configured by a TDD UL/DL configuration for FD functionality; or the RO being not before an SSB in a PRACH slot and starting after a last DL symbol indicated by the TDD UL/DL configuration for FD functionality.

In some embodiments, in response to the fact that the RACH configuration is applicable for all slots, the condition for determining the RO to be within the set of valid ROs further includes the RO being within a DL symbol configured by a TDD UL/DL configuration for non-FD functionality.

In some embodiments, in response to the fact that the RACH configuration is applicable for all slots, the condition for determining the RO to be within the set of valid ROs further includes the RO being within a UL symbol configured by a TDD UL/DL configuration for non-FD functionality.

In some embodiments, the method further includes receiving a first configuration, wherein in response to the fact that the RACH configuration is applicable for all slots and the RO meets the condition, whether the RO is determined to be within the set of valid ROs further depends upon the first configuration.

In some embodiments, in response to the fact that the RACH configuration is applicable for a subset of all slots, the condition for determining the RO to be within the set of valid ROs includes the RO being within a DL symbol configured by a TDD UL/DL configuration for non-FD functionality.

In some embodiments, the set of valid ROs includes at least one of: at least one separate valid RO, or at least one shared valid RO for both FD functionality and non-FD functionality.

In some embodiments, the method further includes receiving at least one SSB associated with the at least one separate valid RO which is separated from at least one SSB associated with at least one RO for non-FD functionality.

In some embodiments, the method further includes receiving a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, the method further includes receiving a third configuration setting a set of preambles in the at least one separate valid RO for a 4-step RA procedure to be available for a 2-step RA procedure.

In some embodiments, the set of preambles are associated with a set of PRUs configured for non-FD functionality.

In some embodiments, the set of preambles are associated with a separate set of PRUs configured for FD functionality different from a set of PRUs configured for non-FD functionality.

According to some embodiments of the present disclosure, an exemplary method performed by a BS is provided. The method includes: transmitting a BWP configuration for at least a UL BWP to a UE, in order to perform reception in the UL BWP with the UE when the BS performs transmission in a DL BWP with another UE; and determining a set of valid ROs within the UL BWP for FD functionality.

In some embodiments, determining the set of valid ROs within the UL BWP includes determining the set of valid ROs within the UL BWP at least based on the BWP configuration.

In some embodiments, the BWP configuration includes a Random Access Channel (RACH) configuration in the UL BWP for FD functionality, wherein the RACH configuration includes at least one of: a PRACH configuration index, or the number of ROs and a start of a first RO within the UL BWP.

In some embodiments, the RACH configuration in the UL BWP for Full Duplex (FD) functionality is applicable for all slots.

In some embodiments, the RACH configuration in the UL BWP for FD functionality is applicable for a subset of all slots.

In some embodiments, a condition for determining an RO to be within the set of valid ROs includes at least one of: the RO being within a UL symbol configured by a TDD UL/DL configuration for FD functionality, or the RO being not before an SSB in a PRACH slot and starting after a last DL symbol indicated by the TDD UL/DL configuration for FD functionality.

In some embodiments, in response to the fact that the RACH configuration is applicable for all slots, the condition for determining the RO to be within the set of valid ROs further includes the RO being not within a UL symbol configured by a TDD UL/DL configuration for non-FD functionality.

In some embodiments, in response to the fact that the RACH configuration is applicable for all slots, the condition for determining the RO to be within the set of valid ROs further includes the RO being within a UL symbol configured by a TDD UL/DL configuration for non-FD functionality.

In some embodiments, the method further includes transmitting a first configuration, wherein in response to the fact that the RACH configuration is applicable for all slots and the RO is within a UL symbol configured by a TDD UL/DL configuration for non-FD functionality, whether the RO is determined to be within the set of valid ROs further depends upon the first configuration.

In some embodiments, in response to the fact that the RACH configuration is applicable for a subset of all slots, the condition for determining the RO to be within the set of valid ROs includes the RO being within a DL symbol configured by a TDD UL/DL configuration for non-FD functionality.

In some embodiments, the set of valid ROs includes at least one of: at least one separate valid RO, or at least one shared valid RO for both FD functionality and non-FD functionality.

In some embodiments, the method further includes transmitting at least one SSB associated with the at least one separate valid RO which is separated from at least one SSB associated with at least one RO for non-FD functionality.

In some embodiments, the method further includes transmitting a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, the method further includes transmitting a third configuration for setting a set of preambles in the at least one separate valid RO to be available for a 2-step RACH procedure.

In some embodiments, the set of preambles are associated with a set of PRUs configured for non-FD functionality.

In some embodiments, the set of preambles are associated with a separate set of PRUs configured for FD functionality different from a set of PRUs configured for non-FD functionality.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates exemplary legacy duplex modes;

FIG. 2 illustrates exemplary duplex modes according to some embodiments of the present disclosure;

FIG. 3 illustrates an exemplary flowchart of a method performed by a UE according to some embodiments of the present disclosure;

FIGS. 4 (including 4(a), 4(b), and 4(c)) illustrates an example about determining a set of valid RO for FD functionality according to some embodiments of the present disclosure:

FIGS. 5 (including 5(a), 5(b), and 5(c)) illustrates an example about determining a set of valid RO for FD functionality according to some embodiments of the present disclosure:

FIG. 6 illustrates an exemplary flowchart of a method performed by a BS according to some embodiments of the present disclosure; and

FIG. 7 illustrates a simplified block diagram of an exemplary apparatus according to some other embodiments of the present disclosure.

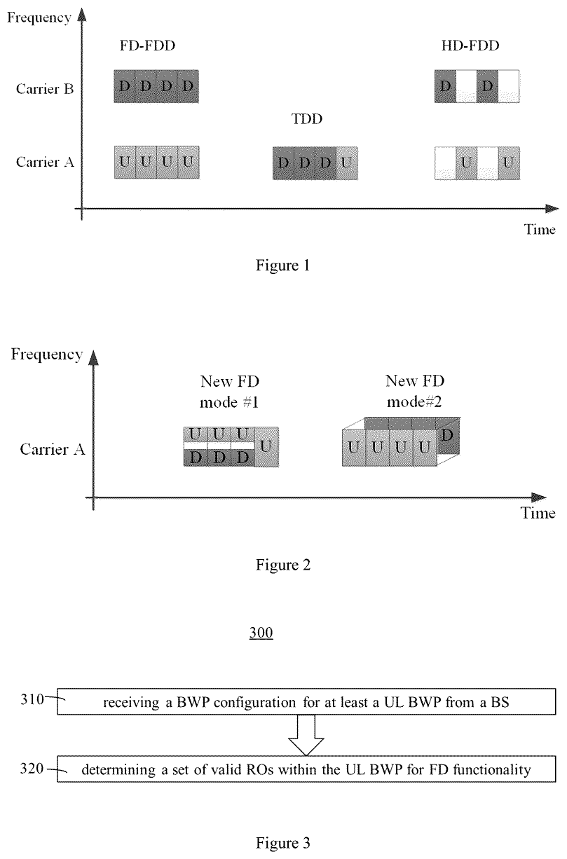

### DETAILED DESCRIPTION

The detailed description of the appended drawings is intended as a description of the currently preferred embodiments of the present invention and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that among all illustrated operations be performed, to achieve desirable results, sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP 5G NR, 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

According to the spirit of the present disclosure, the UEs are not special UEs, they may be computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present disclosure, the UE may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments, the UE may be wearable devices, such as smart watches, fitness bands, optical head-mounted displays, or the like.

In some embodiments of the present disclosure, a BS may be referred to as an access point, an access terminal, a base, a base unit, a macro cell, a wireless node, a Node-B, an enhanced Node-B, an evolved Node B (eNB), a general Node B (gNB), a Home Node-B, a relay node, or a device, or described using other terminology used in the art. The BS is generally part of a radio access network that may include a controller communicably coupled to the BS.

The present disclosure provides various methods, embodiments, and apparatuses for RA procedure in improved full duplex modes. According to some embodiments of the present disclosure, simultaneous transmission and reception by the same device on the same carrier are enabled, which have potential to increase the link throughput than that in the non-full duplex modes, and to reduce the transmission latency due to bidirectional transmission in a time slot.

FIG. 2 illustrates two improved full duplex modes (new FD mode #1 and new FD mode #2) allowing overlapped DL/UL resource occupation. For new FD mode #1, the UL and DL occupy different frequency resources (or different subcarriers, different bandwidth parts (BWPs)) in a same carrier A. For new FD mode #2, the UL and DL link could occupy overlapped resources, which include the same frequency resources.

For new FD mode #2, simultaneous DL and UL in a same carrier (or a same subcarrier) may incur self-interference. Specifically, in the BS side, the DL transmission might contaminate UL reception; while in the UE side, the UL transmission might contaminate DL reception. Apparently, in the new FD mode #1, such self-interference level would be much lower than that in the new FD mode #2 due to the non-overlapped DL and UL resources.

In addition, it would be relatively easier and more feasible to realize full duplex in BS side than in UE side, given the fact that more room is available in the BS side, which enables separation of Tx/Rx antenna branches for interference cancellation. Besides, more advanced transceiver can be deployed in the BS side, which is necessary for self-interference cancellation.

Therefore, some embodiments of the present disclosure concentrates mainly on new FD mode #1 of full duplex in a BS only, and a UE is still using HD operation in a carrier. However, the solutions provided by the present disclosure can also be applicable for some other FD models in either BS side or UE side. Besides, some embodiments of the present disclosure focus on UL performance enhancement in terms of more UL resources for lower latency UL transmission in TDD system. According to some embodiments of the present disclosure, the BS can allocate one set of UEs to use one set of frequency resources for UL, while allocate another set of UEs to occupy another set of frequency domain resource for DL, and the DL and UL resources are available simultaneously in time domain in the same carrier.

As long as there is no special description, a UE mentioned hereinafter referred to an FD-UE.

According to the present disclosure, an FD-UE is a UE that is capable of full duplex or capable of knowing/supporting BS side full duplex operation, or capable of being configured with at least a full duplex slot, or capable of being configured with more than one BWPs used in different slots, or capable of being configured with more than one TDD UL and DL configurations with one slot format configuration overriding the non-flexible slots/symbols from another configuration. The UEs without such capability is named as non-FD UEs.

FIG. 3 illustrates an exemplary flowchart of method 300 performed by a UE according to some embodiments of the present disclosure. It would be appreciated that in method 300 or in other methods or embodiments described later, the UE can be a generic device or an apparatus, or a part of a device or an apparatus that uses the technical solution of the present application.

In operation 310, the UE receiving a BWP configuration for at least a UL BWP from a BS, wherein the BS is able to perform reception in the UL BWP from the UE when the BS performs transmission in a DL BWP to another UE.

In operation 320, the UE determines a set of valid RACH ROs within the UL BWP for FD functionality, in other words, the UE determines whether an RO is valid within the UL BWP.

In some embodiments, the UE determines the set of valid RACH ROs within the UL BWP at least based on the BWP configuration.

In some embodiments, the BWP configuration received in operation 310 is a BWP configuration for a UL BWP for FD usage. The BWP may be a separate BWP specifically for FD usage or it is the BWP for both FD usage and non-FD usage. In some embodiments, the separate BWP is a separate initial BWP for FD-UEs. The BWP configuration includes separate RACH configuration for FD-UEs; and the UE also receives a RACH configuration for non-FD usage, which includes RACH configuration for non-FD usage.

In some embodiments, the separate RACH configuration includes at least one of:
a separate PRACH configuration index indicating the PRACH slots; or
a separate RO configuration in the frequency domain (i.e., the number of ROs and a start of a first RO of the number of ROs within the UL BWP) for determining RACH resources in each PRACH slot.

In some embodiments, the separate RACH configuration is applicable for all the slots; i.e., the PRACH slots are defined over all the slots.

In some embodiments, the separate RACH configuration is applicable for the subset of all the slots; i.e., the PRACH slots are defined over the subset of all the slots. The subset of slots is for FD usage.

For example, assuming the PRACH resource has a 10 ms periodicity, each subframe contains one slot (i.e., with 15 KHz subcarrier spacing); accordingly, there are ten slots 0˜9 in each periodicity. In some embodiments, if the separate PRACH configuration index is {0, 1, 2, 3, 4, 5, 6, 7, 8, 9}, it means all the ten slots may be PRACH slots; if the separate PRACH configuration index is {0, 2, 4, 6, 8}, it means that slots with index 0, 2, 4, 6, 8 may be PRACH slots.

In some embodiments, in operation 310, the separate RACH configuration includes a separate PRACH configuration index and a separate RO configuration in the frequency domain (case 1). In case 1, in operation 320, the UE may determine a set of PRACH slots based on the separate PRACH configuration index, and determine a set of separate ROs based on the separate RO configuration in the set of PRACH slots.

In some embodiments, in operation 310, the separate RACH configuration includes only a separate PRACH configuration index (case 2). Accordingly, in case 2, the UE may determine a set of PRACH slots based on the separate PRACH configuration index. As the separate RACH configuration does not contain a separate RO configuration in the frequency domain, the configuration of ROs in frequency domain for non-FD UEs is reused for the frequency domain ROs determination for the set of PRACH slots; in operation 320, the UE may determine a separate set of ROs based on the separate PRACH configuration index and the configuration of ROs in frequency domain for non-FD UEs.

In some embodiments, in operation 310, the separate RACH configuration includes only a separate RO configuration in the frequency domain (case 3). In case 3, as the separate RACH configuration does not contain a separate PRACH configuration index, the PRACH slots determined by a PRACH configuration index configured for non-FD UEs are reused; in operation 320, the UE may determine a set of separate ROs based on the separate RO configuration in the set of PRACH slots determined by the PRACH configuration index for non-FD UEs.

According to the present disclosure, the separate RACH configuration may contain other RACH related configuration, such as PRACH format and/or total number of available PRACH preambles, which are applicable for the separate ROs for FD-UEs.

In case 1, case 2, or case 3, in operation 320, besides the separate ROs for FD-UEs, the UE also determined a set of ROs for both FD-UEs and non-FD-UEs. Accordingly, the UE may determine a set of valid ROs from the two sets of ROs determined. In other words, the set of valid ROs includes at least one of:
at least one separate valid RO, selected from the set of separate ROs only for FD-UEs, or
at least one shared valid RO for both FD-UEs and non-FD UEs, selected from the set of ROs for both FD-UEs and non-FD UEs.

In some embodiments, the UE determines whether an RO of the two sets of the ROs mentioned above is valid based on at least one condition.

In some embodiments, in case 1, case 2, or case 3, the UE may determine that a separate RO from the set of separate ROs is a valid RO within the UL BWP for FD functionality if the RO meets at least condition 1.

In some embodiments, condition 1 includes at least one of:
an RO is within a UL symbol configured by a TDD UL/DL configuration for FD functionality (e.g., tdd-UL-DL-ConfigCommonAdd); or
an RO is not before an SSB block in a PRACH slot and starts after (e.g., N gap symbols after, wherein N is a non-negative integer) a last DL symbol indicated by the TDD UL/DL configuration for FD functionality.

In case 1, case 2, or in case 3, if the separate RACH configuration is applicable for all the slots, it is possible that there are overlapped PRACH slots determined by the PRACH configuration index for non-FD UEs based on TDD UL/DL configuration tdd-UL-DL-ConfigCommon and by separate PRACH configuration index for FD-UEs based on TDD UL/DL configuration tdd-UL-DL-ConfigCommonAdd. In this case, in some embodiments, some more factors need to be considered.

In some embodiments, a separate RO is a separate valid RO if it meets condition 1 and it is within a DL symbol configured by a TDD UL/DL configuration for non-FD UEs (e.g., idd-UL-DL-ConfigCommon); it means that a separate RO within a PRACH slot not overlapping with a PRACH slot for both FD-UEs and non-FD UEs is a valid separate RO for FD-UEs.

In some embodiments, a separate RO is a separate valid RO if it meets condition 1 and it is within a UL symbol configured by a TDD UL/DL configuration for non-FD functionality; it means that a separate RO being within a PRACH slot overlapping with a PRACH slot for both FD-UEs and non-FD UEs is a separate valid RO for FD-UEs.

In some embodiments, a separate RO being within a PRACH slot overlapping with a PRACH slot for both FD-UEs and non-FD UEs is not a separate valid RO for FD UEs.

In some embodiments, the UE further receives a first configuration; whether a separate RO meeting condition 1 is a separate valid RO further depends upon a first configuration. For example, in some embodiments, the first configuration may configure a separate RO meeting condition 1 and being within a PRACH slot/symbol overlapping with a PRACH slot for both FD-UEs and non-FD UEs to be a separate valid RO within the UL BWP for FD functionality; in some embodiments, the first configuration may configure a separate RO meeting condition 1 and being within a PRACH slot/symbol overlapping with a PRACH slot for both FD-UEs and non-FD UEs not to be a separate valid RO within the UL BWP for FD functionality.

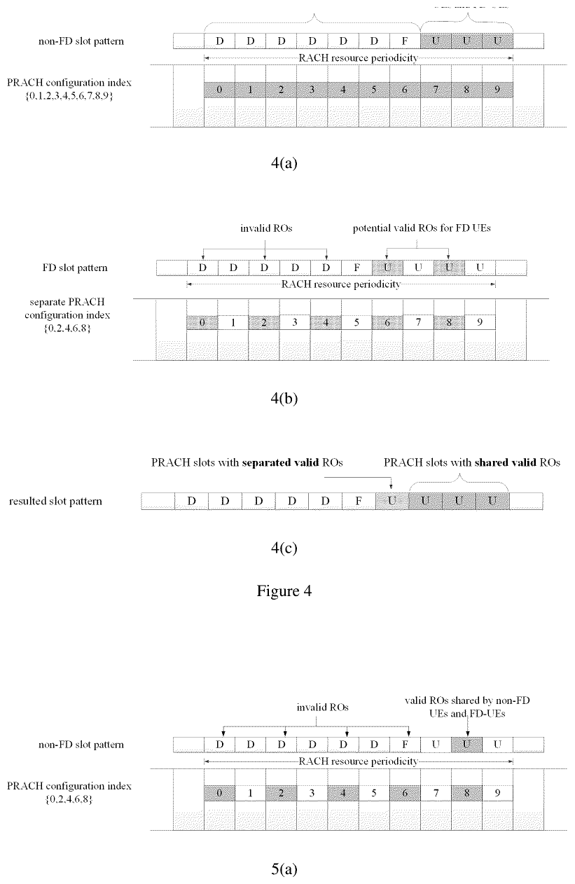

FIGS. 4 (including 4(a), 4(b), and 4(c)) illustrates an example about determining a set of valid ROs for FD UEs for case 1. In this example, it is assumed that the PRACH resource has a periodicity of 10 ms, each subframe contains one slot (i.e., with 15 KHz subcarrier spacing); accordingly, there are ten slots 0˜9 in each periodicity.

FIG. 4(a) illustrates determining a set of ROs where valid ROs for FD usage may be selected from. As shown in FIG. 4(a), a slot pattern “DDDDDDFUUU” is indicated by a cell common TDD UL/DL configuration (e.g., tdd-UL-DL-ConfigCommon) for non-FD usage in a cell, wherein “D” means a DL slot, “U” means a UL slot, and “F” means a slot with flexible symbols. The PRACH configuration index indicates that all the slots 0˜9 are PRACH slots. Since PRACH slots 0˜6 are not for UL transmission, the ROs associated with PRACH slots 0˜6 are not within UL symbols; accordingly, the ROs associated with PRACH slots 0˜6 are invalid ROs for non-FD UEs. Slots 7˜9 are for UL transmission, and the ROs associated with PRACH slots 7˜9 are within UL symbols, accordingly, the ROs associated with PRACH slots 7˜9 are valid ROs shared by non-FD UEs and FD-UEs.

FIG. 4(b) illustrates determining a set of separate ROs where valid ROs for FD usage may be selected from. In this example, the UE is configured with a TDD UL/DL configuration for FD functionality (e.g., tdd-UL-DL-ConfigCommonAdd) indicating a FD slot pattern “DDDDDFUUUU” for FD usage, wherein “D” is a DL slot, “U” is a UL slot, and “F” means a slot with flexible symbols, as shown in FIG. 4(b). In this example, the UE receives a BWP configuration for a UL BWP for FD usage in operation 310, wherein the BWP configuration includes a separate RACH configuration index indicates that slots 0, 2, 4, 6, and 8 are PRACH slots. As PRACH slots (0˜5 are not UL slots, their associated separate ROs are not invalid ROs. PRACH slots 6˜9 are UL slots and thus their associated separate ROs are considered as potential valid ROs for FD UEs.

FIG. 4(c) illustrates selecting a set of valid ROs for FD functionality from the set of ROs determined in the steps corresponding to FIG. 4(a) and the set of separate ROs determined in the steps corresponding to FIG. 4(b). A UL symbol/slot indicated by tdd-UL-DL-ConfigCommonAdd could override a DL symbol/slot or a flexible symbol/slot indicated by tdd-UL-DL-ConfigCommon. Based on this, FIG. 4(c) illustrates a resulted slot pattern “DDDDDFUUUU” for FD UEs. ROs associated with PRACH slots 6 and 8 are within UL symbols/slots configured by tdd-UL-DL-ConfigCommonAdd and thus meet condition 1. In this example, PRACH slot 6 does not have overlapped PRACH slots determined from FIG. 4(a), while PRACH slot 8 is a PRACH slot determined in both FIG. 4(a) and FIG. 4(b).

In this example, a separate RO is determined to be a separate valid RO if it meets condition 1 and it is not within an overlapped PRACH slots; thus it is determined that the PRACH slot 6 contains separate valid ROs only for FD UEs; PRACH slot 8 does not contain separate valid ROs only for FD usage, but contains shared valid ROs for both FD-UEs and non-FD UEs. As a result, the set of valid ROs for FD can be determined, it contains:
at least one separated valid ROs only for FD-UEs, which is at least one separate RO associated with PRACH slot 6; and
at least one shared valid ROs for both FD-UEs and non-FD UEs, which is at least one RO associated with PRACH slots 7˜9.

In the example illustrated in FIG. 4, two sets of valid ROs are determined: one is the set of separate valid ROs for FD-UEs within the UL BWP for FD functionality, another is a set of shared valid ROs for both FD-UEs and non-FD-UEs.

In the example illustrated in FIG. 4, the frequency domain RO configuration for PRACH slot 6 and the frequency domain RO configuration for PRACH slots 7-9 are different. In some embodiments, the BWP for non-FD UEs and the BWP for FD-UEs are different, and the separate valid ROs only for FD UEs are within the UL BWP configured with the BWP configuration received in operation 310 for FD-usage, and the shared valid ROs are within a BWP configured with a BWP configuration for non-FD usage. In some embodiment, the BWP for non-FD UEs and FD-UEs are the same, and the separate valid ROs only for FD UEs and the shared valid ROs are within the same UL BWP configured with the BWP configuration received in operation 310.

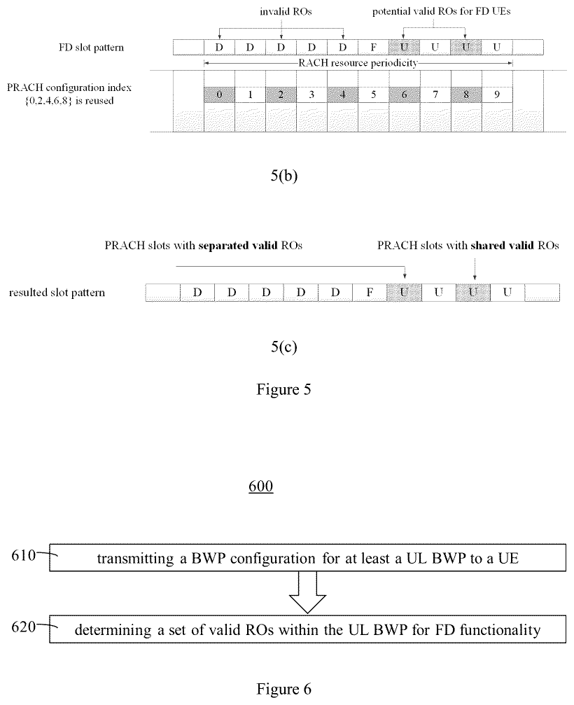

FIGS. 5 (including 5(a), 5(b), and 5(c)) illustrates an example about determining a set of valid ROs for FD UEs for case 3. In this example, it is assumed that the PRACH resource has a periodicity of 10 ms, each subframe contains one slot (i.e., with 15 KHz subcarrier spacing), accordingly, there are ten slots 0˜9 in each periodicity.

FIG. 5(a) illustrates determining a set of ROs where valid ROs for FD UEs may be selected from. As shown in FIG. 4(a), a slot pattern “DDDDDDFUUU” is indicated by a cell common TDD UL/DL configuration (e.g., tdd-UL-DL-ConfigCommon) for non-FD UEs in a cell, wherein “D” means a DL slot, “U” means a UL slot, and “F” means a slot with flexible symbols. The PRACH configuration index indicates that slots 0, 2, 4, 6, and 8 are PRACH slots. Since slots 0˜6 are not for UL transmission, the ROs associated with slots 0˜6 are not within UL symbols; accordingly, the ROs associated with PRACH slots 0, 2, 4, and 6 are invalid ROs for non-FD UEs. PRACH slot 8 is for UL transmission, the ROs associated with PRACH slot 8 are within UL symbols; accordingly, the ROs associated with PRACH slot 8 are valid ROs shared by FD-UEs and non-FD UEs.

FIG. 5(b) illustrates determining a set of separate ROs where valid ROs for FD UEs may be selected from. In this example, the UE is configured with a TDD UL/DL configuration for FD functionality (e.g., tdd-UL-DL-ConfigCommonAdd) indicating a slot pattern “DDDDDFUUUU” for FD usage, wherein “D” is a DL slot, “U” is a UL slot, and “F” means a slot with flexible symbols, as shown in FIG. 4(b). In this example, the UE receives a BWP configuration for a UL BWP for FD usage in operation 310, wherein the BWP configuration does not include a separate RACH configuration index; therefore, the RACH configuration index for non-FD UEs is reused, i.e., slots 0, 2, 4, 6, and 8 are PRACH slots. As PRACH slots 0, 2, and 4 are not UL slots, their associated separate ROs are invalid ROs for FD-UEs. PRACH slots 6 and 8 are UL slots and thus their associated separate ROs are potential valid ROs for FD UEs.

FIG. 5(c) illustrates selecting a set of valid ROs for FD UEs from the set of ROs determined in the steps corresponding to FIG. 5(a) and the set of separate ROs determined in the steps corresponding to FIG. 5(b). A UL symbol/slot indicated by tdd-UL-DL-ConfigCommonAdd could override a DL symbol/slot or a flexible symbol/slot indicated by tdd-UL-DL-ConfigCommon. Accordingly. FIG. 5(c) illustrates a resulted slot pattern “DDDDDFUUUU.” ROs associated with PRACH slots 6 and 8 are within UL symbols/slots configured by tdd-UL-DL-ConfigCommonAdd and thus meet condition 1. In this example, PRACH slot 6 does not have overlapped PRACH slots determined from FIG. 5(a), while PRACH slot 8 is a PRACH slot determined in both FIG. 5(a) and FIG. 5(b).

In this example, a separate RO is determined to be a separate valid RO if it meets condition 1 and it is not within an overlapped PRACH slots; thus it is determined that the PRACH slot 6 contains separate valid ROs only for FD usage; thus, it is determined that the PRACH slot 6 contains separate valid ROs only for FD usage; PRACH slot 8 does not contain separate valid ROs only for FD usage, but contains shared valid ROs for both FD-UEs and non-FD UEs.

In the example illustrated in FIG. 5, two sets of valid ROs are determined: one is the set of separate valid ROs for FD-UEs within the UL BWP for FD functionality, another is a set of shared valid ROs for both FD-UEs and non-FD-UEs.

In the example illustrated in FIG. 5, the frequency domain RO configuration for PRACH slot 6 and the frequency domain RO configuration for PRACH slot 8 are different. In some embodiments, the BWP for non-FD UEs and the BWP for FD-UEs are different; the separate valid ROs only for FD UEs are within the UL BWP configured with the BWP configuration received in operation 310 for FD-usage, and the shared valid ROs are within a BWP configured with a BWP configuration for non-FD usage. In some embodiment, the BWP for non-FD UEs and FD-UEs are the same, and the separate valid ROs only for FD UEs and the shared valid ROs are within the same UL BWP configured with the BWP configuration received in operation 310.

In some embodiments, the separate RACH configuration is applicable for a subset of all the slots on the UL BWP; in this case, a separate RO from the set of separate ROs is determined to be a separate valid RO within the UL BWP for FD functionality if it meets condition 2.

In some embodiments, condition 2 includes at least that an RO is within a DL symbol/slot configured by a TDD UL/DL configuration for non-FD functionality (e.g., tdd-UL-DL-ConfigCommon), and it is within UL symbols of a TDD UL/DL configuration for FD functionality (e.g., tdd-UL-DL-ConfrgCommonAdd).

In some embodiments, according to the present disclosure, the association of SSBs with the separate valid ROs only for FD-UEs is separated from the association of SSBs with the ROs shared for both non-FD UEs and FD-UEs. An advantage is that the solution of the present disclosure may be backward compatible with the legacy non-FD functionality and not affect non-FD UEs.

In some embodiments, the UE can be provided with a separate configuration, which provides a number of SSB indexes associated with the separate valid ROs only for FD functionality and a number of contention-based preambles per SSB index per valid separate valid ROs; herein the separate valid RO is a separate RO of the set of valid ROs for FD.

The separate valid ROs are indexed for the SSB to RO association. The association may be performed following the legacy principle, i.e., firstly in increasing order of preamble indexes within a single separate valid RO, then in the increasing order of frequency resource indexes for frequency multiplexed separate valid ROs, then in increasing order of time resource indexes for time multiplexed separate valid ROs with a separate PRACH slot, lastly in increasing order of indexes of separate PRACH slots.

An association period is determined separately for mapping SSB indexes to the separate valid ROs. The association period is determined such that the SSB are mapped at least once to the separate valid ROs within the association period.

In some embodiments, method 300 further includes receiving a second configuration for a power ramping step. This power ramping step is used for retransmitting preamble if the preamble is initially transmitted in a separate valid RO, or it is retransmitted in a separate valid RO. In some embodiment, the power ramping step is used for re-transmission of a preamble in a first RO of the at least one separate valid RO if the latest transmission of the preamble is in a second RO of the at least one separate valid RO, wherein the first RO is the same as or different from the second RO.

There may be different interference level undergoing in the FD slots than in the non-FD slots and the potential different PRACH format configured for the separate valid ROs and for the shared valid ROs, herein the separate valid ROs are separate ROs within the set of valid ROs for FD functionality, and the shared valid ROs are ROs within the set of valid ROs for FD functionality. Therefore, some embodiments of the present disclosure provide the second configuration for a separate power ramping step, which is used for the retransmitted preamble in a first RO of the separate valid ROs when the latest transmission is in a second RO of the separate valid ROs.

According to some embodiments of the present disclosure, the power ramping operation may be predefined or may be based on a configuration.

In one embodiment, in the case that the latest transmission is in a separate valid RO, while the retransmission is in a shared valid RO, and/or in the case that the latest transmission is in a shared valid RO, while the retransmission is in a separate valid RO, no power ramping is needed.

In one embodiment, whether power ramping is needed in such cases is based on BS configuration, or the UE follows a predefined rule to determine whether the power ramping is needed, e.g., if the latest transmission in a shared valid RO while the retransmission in a separate valid RO, power ramping needed. While if the latest transmission is in a separate valid RO, while the retransmission in a shared valid RO, then power ramping is not needed.

According to the present disclosure, an RA procedure may be a 2-step RA procedure, or may be a 4-step RA procedure.

In some embodiments, the separate ROs for 2-step RA procedure are configured different from the separate ROs for 4-step RA procedure.

In some embodiments, method 300 further includes receiving a third configuration setting a set of preambles in the at least one separate valid RO for a 4-step RA procedure to be available for a 2-step RA procedure.

In some embodiments, the set of preambles are associated with a set of PUSCH PRUs configured for non-FD functionality.

In some embodiments, the set of preambles are associated with a separate set of PRUs configured for FD functionality different from a set of PRUs configured for non-FD functionality.

In some embodiments, in operation 310, the separate RACH configuration does not includes a separate PRACH configuration index and a separate RO configuration in the frequency domain (case 4), the UE determines a same set of ROs with the non-FD UEs; i.e., the UE does not determine a separate set of ROs.

In some embodiments, in operation 310, the RACH configuration is not a separate RACH configuration for a UL BWP for FD functionality (case 4′), the UE determines a same set of ROs with the non-FD UEs; i.e., the UE does not determine a separate set of ROs.

The FD-UE is not configured with separate RACH configuration, or the UE is configured with separate RACH configuration but without PRACH configuration index and frequency domain RO configurations. In this case, the UE determines a same set of ROs with the non-FD UEs.

It is appreciated that, according to the present disclosure, a BS may perform methods corresponding to method performed by the UE.

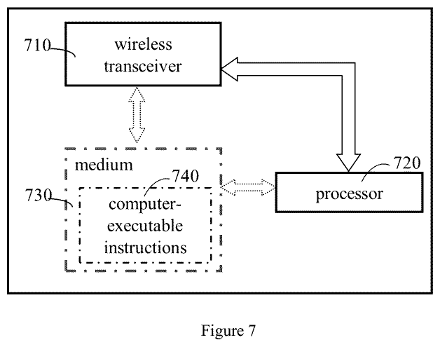

FIG. 6 illustrates an exemplary flowchart of method 600 performed by a BS corresponding to method 300 performed by the UE. It would be appreciated that in method 600 or in other methods or embodiments described later, the BS is not a special BS; it can be a generic device or an apparatus, or a part of a device or an apparatus that uses the technical solution of the present disclosure.

In operation 610, the BS transmits a BWP configuration for at least a UL BWP to a UE, in order to perform reception in the UL BWP with the UE when the BS performs transmission in a DL BWP with another UE.

In operation 620, the BS determines a set of valid ROs within the UL BWP for FD functionality.

In some embodiments, in operation 620, the BS determines the set of valid ROs within the UL BWP at least based on the BWP configuration.

In some embodiments, BWP configuration includes an RACH configuration in the UL BWP for FD functionality, wherein the RACH configuration includes at least one of:
a PRACH configuration index, or
the number of ROs and a start of a first RO within the UL BWP.

In some embodiments, the RACH configuration in the UL BWP for FD functionality is applicable for all slots.

In some embodiments, the RACH configuration in the UL BWP for FD functionality is applicable for a subset of all slots.

In some embodiments, a condition for determining an RO to be within the set of valid ROs includes at least one of:
the RO being within a UL symbol configured by a Time Division Duplexing (TDD) UL/DL configuration for FD functionality; or
the RO being not before a Synchronization Signal Block (SSB) block in a PRACH slot and starting after a last DL symbol indicated by the TDD UL/DL configuration for FD functionality.

In some embodiments, if the RACH configuration is applicable for all slots, the condition for determining the RO to be within the set of valid ROs further includes that the RO is not within a UL symbol configured by a TDD UL/DL configuration for non-FD functionality.

In some embodiments, if the RACH configuration is applicable for all slots, the condition for determining the RO to be within the set of valid ROs further includes that the RO is within a UL symbol configured by a TDD UL/DL configuration for non-FD functionality.

In some embodiments, method 600 further includes transmitting a first configuration, wherein in response to the fact that the RACH configuration is applicable for all slots and the RO is within a UL symbol configured by a TDD UL/DL configuration for non-FD functionality, whether the RO is determined to be within the set of valid ROs further depends upon the first configuration.

In some embodiments, if the RACH configuration is applicable for a subset of all slots, the condition for determining the RO to be within the set of valid ROs includes that the RO is within a DL symbol configured by a TDD UL/DL configuration for non-FD functionality.

In some embodiments, the set of valid ROs includes at least one of:
at least one separate valid RO, selected from the set of separate ROs only for FD functionality; or
at least one shared valid RO for both FD functionality and non-FD functionality.

In some embodiments, method 600 further includes transmitting at least one SSB associated with the at least one separate valid RO which is separated from at least one SSB associated with at least one RO for non-FD functionality.

In some embodiments, method 600 further includes transmitting a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, method 600 further includes transmitting a third configuration for setting a set of preambles in the at least one separate valid RO to be available for a 2-step RACH procedure.

In some embodiments, the set of preambles are associated with a set of PUSCH PRUs configured for non-FD functionality.

In some embodiments, the set of preambles are associated with a separate set of PRUs configured for FD functionality different from a set of PRUs configured for non-FD functionality.

In this disclosure various methods and embodiments are provided for RA procedures in full duplex mode.

According to some embodiments of the present disclosure, an FD-UE (i.e., an UE supporting FD functionality) could determine two set of ROs, one contains ROs shared with non-FD UEs, while the other contains separate ROs for FD-UEs.

According to the present disclosure, in some embodiments, the FD-UE may determine a separate valid RO within a UL BWP for FD functionality from proposed condition 1. In some embodiments, some other factors may be taken into consider as well.

According to the present disclosure, in some embodiments, the FD-UE may determine a separate valid RO within a UL BWP for FD functionality from proposed condition 2.

According to some embodiments of the present disclosure, separate RO to SSB association for the separate valid ROs is proposed.

Some embodiments of the present disclosure introduces a configuration for a separate power ramping step, which is used for the retransmitted preamble in the separate valid RO when the latest transmission is in a separate valid RO as well. For other cases, the power ramping operation is predefined or is based on a configuration.

According to some embodiments of the present disclosure, the FD-UE can further be provided with a configuration, based on which a set of preambles in the separate valid ROs for 4-step RACH usage can be used for 2-step RACH usage. As one option, these preambles are associated with the PRUs configured for non-FD UEs. As another option, these preambles are associated with separate configured PRUs.

FIG. 7 illustrates a simplified block diagram of an exemplary apparatus 700 according to various embodiments of the present disclosure.

In some embodiments, apparatus 700 may be or include at least a part of an UE or similar device having similar SL functionality.

In some embodiments, apparatus 700 may be or include at least a part of a BS or similar device that can use the technology of the present disclosure.

As shown in FIG. 7, apparatus 700 may include at least wireless transceiver 710 and processor 720, wherein wireless transceiver 710 may be coupled to processor 720. Furthermore, apparatus 70) may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments, wireless transceiver 710, non-transitory computer-readable medium 730, and processor 720 may be coupled to each other via one or more local buses.

Although in FIG. 7, elements such as wireless transceiver 710, non-transitory computer-readable medium 730, and processor 720 are described in the singular, the plural is contemplated unless limitation to the singular is explicitly stated. In some embodiments of the present disclosure, wireless transceiver 710 may be configured for wireless communication. In some embodiments of the present disclosure, wireless transceiver 710 can be integrated into a transceiver. In certain embodiments of the present disclosure, the apparatus 700 may further include other components for actual usage.

In some embodiments, apparatus 700 is an UE or at least a part of an UE. Processor 720 is configured to cause the apparatus 700 at least to perform, with wireless transceiver 710, any method described above which is performed by an UE according to the present disclosure.

In some embodiments, processor 720 is configured to, with wireless transceiver 710, receive, with wireless transceiver 720, a BWP configuration for at least a UL BWP from a BS, and determine a set of valid ROs within the UL BWP for FD functionality, wherein the BS is able to perform reception in the UL BWP with the UE when the BS performs transmission in a DL BWP with another UE.

In some embodiments, to determine the set of valid ROs within the UL BWP, processor 720 is further configured to determine the set of valid ROs within the UL BWP at least based on the BWP configuration.

In some embodiments, the BWP configuration includes an RACH configuration in the UL BWP for FD functionality, wherein the RACH configuration includes at least one of: a separate PRACH configuration index, or the number of ROs and a start of a first RO within the UL BWP.

In some embodiments, the RACH configuration in the UL BWP for FD functionality is applicable for all slots.

In some embodiments, the RACH configuration in the UL BWP for FD functionality is applicable for a subset of all slots.

In some embodiments, wherein a condition for determining an RO to be within the set of valid ROs includes at least one of:
the RO being within a UL symbol configured by a TDD UL/DL configuration for FD functionality; or
the RO being not before a SSB block in a PRACH slot and starting after a last DL symbol indicated by the TDD UL/DL configuration for FD functionality.

In some embodiments, in response to the fact that the RACH configuration is applicable for all slots, the condition for determining the RO to be within the set of valid ROs further includes the RO being within a DL symbol configured by a TDD UL/DL configuration for non-FD functionality.

In some embodiments, in response to the fact that the RACH configuration is applicable for all slots, the condition for determining the RO to be within the set of valid ROs further includes the RO being within a UL symbol configured by a TDD UL/DL configuration for non-FD functionality.

In some embodiments, processor 720 is further configured to receive, with wireless transceiver 710, a first configuration, wherein in response to the fact that the RACH configuration is applicable for all slots and the RO meets the condition, whether the RO is determined to be within the set of valid ROs further depends upon the first configuration.

In some embodiments, in response to the fact that the RACH configuration is applicable for a subset of all slots, the condition for determining the RO to be within the set of valid ROs includes the RO being within a DL symbol configured by a TDD UL/DL configuration for non-FD functionality.

In some embodiments, the set of valid ROs includes at least one of:
at least one separate valid RO, or
at least one shared valid RO for both FD functionality and non-FD functionality.

In some embodiments, processor 720 is further configured to receive, wireless transceiver 710, at least one SSB associated with the at least one separate valid RO which is separated from at least one SSB associated with at least one RO for non-FD functionality.

In some embodiments, processor 720 is further configured to, with wireless transceiver 710, receive a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, processor 720 is further configured to, with wireless transceiver 710, receive a third configuration setting a set of preambles in the at least one separate valid RO for a 4-step RA procedure to be available for a 2-step RA procedure.

In some embodiments, the set of preambles are associated with a set of PRUs configured for non-FD functionality.

In some embodiments, the set of preambles are associated with a separate set of PRUs configured for FD functionality different from a set of PRUs configured for non-FD functionality.

In some embodiments, apparatus 700 is a BS or at least a part of a BS that can use the technology of the present disclosure. Processor 720 is configured to cause the apparatus 700 at least to perform, with wireless transceiver 710, any method described above which is performed by a BS according to the present disclosure.

In some embodiments, processor 720 is configured to, with wireless transceiver 710, transmit, with wireless transceiver 710, a BWP configuration for at least a UL BWP to a UE, in order to perform reception in the UL BWP with the UE when the BS performs transmission in a DL BWP with another UE, and determine a set of valid ROs within the UL BWP for Full FD functionality.

In some embodiments, to determine the set of valid ROs within the UL BWP, processor 720 is further configured to determine the set of valid ROs within the UL BWP at least based on the BWP configuration.

In some embodiments, the BWP configuration includes an RACH configuration in the UL BWP for FD functionality, wherein the RACH configuration includes at least one of:
a PRACH configuration index, or
the number of ROs and a start of a first RO within the UL BWP.

In some embodiments, the RACH configuration in the UL BWP for FD functionality is applicable for all slots.

In some embodiments, the RACH configuration in the UL BWP for FD functionality is applicable for a subset of all slots.

In some embodiments, a condition for determining an RO to be within the set of valid ROs includes at least one of:
the RO being within a UL symbol configured by a Time Division Duplexing (TDD) UL/DL configuration for FD functionality; or
the RO being not before a Synchronization Signal Block (SSB) in a PRACH slot and starting after a last DL symbol indicated by the TDD UL/DL configuration for FD functionality.

In some embodiments, in response to the fact that the RACH configuration is applicable for all slots, the condition for determining the RO to be within the set of valid ROs further includes the RO being not within a UL symbol configured by a TDD UL/DL configuration for non-FD functionality.

In some embodiments, in response to the fact that the RACH configuration is applicable for all slots, the condition for determining the RO to be within the set of valid ROs further includes the RO being within a UL symbol configured by a TDD UL/DL configuration for non-FD functionality.

In some embodiments, processor 720 is further configured to transmit, with wireless transceiver 710, a first configuration, wherein in response to the fact that the RACH configuration is applicable for all slots and the RO is within a UL symbol configured by a TDD UL/DL configuration for non-FD functionality, whether the RO is determined to be within the set of valid ROs further depends upon the first configuration.

In some embodiments, in response to the fact that the RACH configuration is applicable for a subset of all slots, the condition for determining the RO to be within the set of valid ROs includes the RO being within a DL symbol configured by a TDD UL/DL configuration for non-FD functionality.

In some embodiments, the set of valid ROs includes at least one of:
at least one separate valid RO, or
at least one shared valid RO for both FD functionality and non-FD functionality.

In some embodiments, processor 720 is further configured to transmit, with wireless transceiver 710, at least one SSB associated with the at least one separate valid RO which is separated from at least one SSB block associated with at least one RO for non-FD functionality.

In some embodiments, processor 720 is further configured to transmit, with wireless transceiver 710, a second configuration for a power ramping step, wherein the power ramping step is used for re-transmission of a preamble in a first RO of the at least one separate valid RO if the latest transmission of the preamble is in a second RO of the at least one separate valid RO, wherein the first RO is the same as or different from the second RO.

In some embodiments, processor 720 is further configured to transmit, with wireless transceiver 710, a third configuration for setting a set of preambles in the at least one separate valid RO to be available for a 2-step RACH procedure.

In some embodiments, the set of preambles are associated with a set of PRUs configured for non-FD functionality.

In some embodiments, the set of preambles are associated with a separate set of PRUs configured for FD functionality different from a set of PRUs configured for non-FD functionality.

In various example embodiments, processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, processor 720 may also include at least one other circuitry or element not shown in FIG. 7.

In various example embodiments, non-transitory computer-readable medium 730 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, non-transitory computer-readable medium 730 may include, but is not limited to, an electric, a magnetic, an optical, an electromagnetic, an infrared, or a semiconductor system, apparatus, or device or any combination of the above.

Further, in various example embodiments, exemplary apparatus 700 may also include at least one other circuitry, element, and interface, for example antenna element, and the like.

In various example embodiments, the circuitries, parts, elements, and interfaces in exemplary apparatus 700, including processor 720 and non-transitory computer-readable medium 730, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including.” “having,” and the like, as used herein, are defined as “comprising.”

1. A user equipment (UE) for wireless communication, comprising:
at least one memory; and
at least one processor coupled with the at least one memory and configured to cause the UE to:
receive a bandwidth part configuration for at least an uplink (UL) bandwidth part from a base station (BS); and
determine a set of valid Random Access Channel (RACH) Occasions (ROs) within the UL bandwidth part for Full Duplex (FD) functionality, wherein
the UL bandwidth part and a downlink (DL) bandwidth part are available simultaneously in time domain in a same carrier.

2. The UE of claim 1, wherein to determine the set of valid ROs within the UL bandwidth part, the at least one processor is further configured to cause the UE to determine the set of valid ROs within the UL bandwidth part at least based on the bandwidth part configuration, wherein the bandwidth part configuration includes a Random Access Channel (RACH) configuration in the UL bandwidth part for FD functionality, and wherein the RACH configuration includes at least one of:
a separate Physical Random Access Channel (PRACH) configuration index, or
a number of ROs and a start of a first RO within the UL bandwidth part.

3. (canceled)

4. The UE of claim 2, wherein the RACH configuration in the UL bandwidth part for FD functionality is applicable for all slots.

5. The UE of claim 2, wherein the RACH configuration in the UL bandwidth part for FD functionality is applicable for a subset of all slots, which are used for full duplex.

6. The UE of claim 2 wherein a condition for determining an RO to be within the set of valid ROs comprises at least one of:
the RO being within a UL symbol configured by a Time Division Duplexing (TDD) UL/DL configuration for FD functionality; or
the RO being not before a Synchronization Signal Block (SSB) in a PRACH slot and starting after a last DL symbol indicated by the TDD UL/DL configuration for FD functionality.

7. The UE of claim 6, wherein in response to the RACH configuration being applicable for all slots, the condition for determining the RO to be within the set of valid ROs further comprises:
the RO being within a DL symbol configured by a TDD UL/DL configuration for non-FD functionality.

8. The UE of claim 6, wherein in response to the RACH configuration being applicable for all slots, the condition for determining the RO to be within the set of valid ROs further comprises:
the RO being within a UL symbol configured by a TDD UL/DL configuration for non-FD functionality.

9. The UE of claim 6, wherein the at least one processor is further configured to cause the UE to receive a first configuration, wherein in response to the RACH configuration being applicable for all slots and the RO meets the condition, whether the RO is within the set of valid ROs further depends upon the first configuration.

10. The UE of claim 6, wherein in response to the RACH configuration being applicable for a subset of all slots, the condition for determining the RO to be within the set of valid ROs comprises:
the RO being within a DL symbol configured by a TDD UL/DL configuration for non-FD functionality.

11. The UE of claim 1, wherein the set of valid ROs includes at least one of:
at least one separate valid RO, or
at least one shared valid RO for both FD functionality and non-FD functionality.

12. The UE of claim 11, wherein the at least one processor is further configured to cause the UE to receive at least one Synchronization Signal Block (SSB) associated with the at least one separate valid RO which is separated from at least one SSB associated with at least one RO for non-FD functionality.

13. The UE of claim 11, wherein the at least one processor is further configured to cause the UE to receive a second configuration for a power ramping step, wherein the power ramping step is used for re-transmission of a preamble in a first RO of the at least one separate valid RO if a latest transmission of the preamble is in a second RO of the at least one separate valid RO, wherein the first RO is the second RO or is different from the second RO.

14. The UE of claim 11, wherein the at least one processor is further configured to cause the UE to receive a third configuration setting a set of preambles in the at least one separate valid RO for a 4-step Random Access (RA) procedure to be available for a 2-step RA procedure.

15. A base station (BS) for wireless communication, comprising:
at least one memory; and
at least one processor coupled with the at least one memory and configured to cause the BS to:
transmit a bandwidth part configuration for at least an uplink (UL) bandwidth part to a user equipment (UE) in order to perform reception in the UL bandwidth part with the UE when the BS performs transmission in a downlink (DL) BWP with another UE; and
determine a set of valid Physical Random Access Channel (RACH) Occasions (ROs) within the UL BWP for Full Duplex (FD) functionality.

16. The UE of claim 14, wherein for the 2-step RA procedure, the set of preambles are associated with a set of Physical Uplink Shared Channel (PUSCH) Resource Units (PRUs) configured for non-FD functionality, or associated with a set of Physical Uplink Shared Channel (PUSCH) Resource Units (PRUs) configured for non-FD functionality.

17. A processor for wireless communication, comprising:
at least one controller coupled with at least one memory and configured to cause the processor to:
receive a bandwidth part configuration for at least an uplink (UL) bandwidth part from a base station (BS); and
determine a set of valid Random Access Channel (RACH) Occasions (ROs) within the UL bandwidth part for Full Duplex (FD) functionality, wherein
the UL bandwidth part and a downlink (DL) bandwidth part are available simultaneously in time domain in a same carrier.

18. The processor of claim 17, wherein to determine the set of valid ROs within the UL bandwidth part, the at least one controller is further configured to cause the processor to determine the set of valid ROs within the UL bandwidth part at least based on the bandwidth part configuration, wherein the bandwidth part configuration includes a Random Access Channel (RACH) configuration in the UL bandwidth part for FD functionality, and wherein the RACH configuration includes at least one of:
a separate Physical Random Access Channel (PRACH) configuration index, or
a number of ROs and a start of a first RO within the UL bandwidth part.

19. The processor of claim 18, wherein the RACH configuration in the UL bandwidth part for FD functionality is applicable for all slots.

20. The processor of claim 17, wherein the set of valid ROs includes at least one of:
at least one separate valid RO, or
at least one shared valid RO for both FD functionality and non-FD functionality.

21. A method performed by a user equipment (UE), the method comprising:
receiving a bandwidth part configuration for at least an uplink (UL) bandwidth part from a base station (BS); and
determining a set of valid Random Access Channel (RACH) Occasions (ROs) within the UL bandwidth part for Full Duplex (FD) functionality, wherein
the UL bandwidth part and a downlink (DL) bandwidth part are available simultaneously in time domain in a same carrier.
